(19) United States
(12) Patent Application Publication
(10) Pub. No.: US 2008/0093866 A1
(43) Pub. Date: Apr. 24, 2008

(54) Latch Striker with Integral Striker Bar

(76) Inventors: Liviu Bolbocianu, North York (CA); Vladimir Beserminji, North York (CA)

Correspondence Address: MAGNA INTERNATIONAL, INC., 337 MAGNA DRIVE, AURORA, ON, L4G-7K1, CA

(21) Appl. No.: 11/718,841

(22) PCT Filed: Nov. 18, 2005
(86) PCT No.: PCT/CA05/01748

§ 371 Date: May 8, 2007

Related U.S. Application Data
(60) Provisional application No. 60/629,638, filed on Nov. 19, 2004.

(51) Int. Cl. E05B 65/12; E05B 15/02; B23P 15/00

(52) U.S. Cl. 292/340; 29/557

(57) ABSTRACT

A single piece striker for a latch, comprising a mounting plate with an integral striker bar. The striker bar extends out from the mounting plate via a neck portion. The engagement area of the striker bar has a greater diameter than the thickness of the mounting plate. The striker is formed using a progressive die. The striker bar is formed by compressing a portion of the stock to a greater thickness than the rest of the striker. Compressing a portion of the stock also provides a rounded engagement area across the length of the striker bar.

### FIELD OF THE INVENTION

The invention generally relates to latch assemblies. More specifically, the invention relates to a latch striker for an automotive vehicle.

### BACKGROUND OF THE INVENTION

Currently, U-bolt style latch strikers are typically formed from two components, a base and a striker bar. The base is formed using a stamped, sheet metal component that can be mounted to a vehicle body. The striker bar is mounted to the base and extends out from the base to receives a ratchet and pawl assembly located on a latch. The striker bar must be sufficiently thick enough to withstand the stress of both conventional use and accident damage (in accordance with government safety standards). A rounded engagement surface on the striker bar is preferred, as it provides a smooth latching surface for the ratchet and pawl assembly.

The striker bar is typically formed from a wire since conventional stamping does not provide a striker bar of satisfactory thickness and roundedness across the full length and surface area of the striker bar. The wire is bent into the striker shape, and then mounted to the base, typically by hot staking. While meeting operational requirements, the conventional assembly of a latch striker can be time consuming and it can be difficult to achieve the tight tolerances required for automotive vehicles.

Attempts have been made to produce a less-expensive and more precise striker by forming the striker directly from the sheet metal base instead of attaching a wire striker. U.S. Pat. No. 6,692,042 (hereafter the '042 patent) teaches a simplified latch striker formed from welding together two symmetrical L-shaped plates. Using two formed pieces placed together, stamped sheet metal can provide the required thickness and strength for the striker bar. Cap welding around the two halves of the striker bar rounds the engagement surface and helps to reduce the seam created between the two welded L-shaped plates. While this process may be more efficient than hot-staking a separate wire striker bar, welding is still required, increasing both the costs and the weight of the striker. The '042 patent also teaches a latch striker created by bending a sheet metal component in half, negating the need to weld two plates together. However, cap-welding of the seem formed between the two halves in the region of the engagement surface is still required.

It is still desired to provide a latch striker that can be manufactured from a single piece of sheet metal, does not require additional welding or assembly, achieves a high level of precision, and reduces the weight of the striker while maintaining the required thickness, strength and roundedness of the striker bar.

### OBJECT OF THE INVENTION

It is an object of the invention to obviate or mitigate at least one of the disadvantages of the prior art. According to a first aspect of the invention, there is provided a single piece striker for a latch. The striker includes a mounting plate, operable to be mounted to a vehicle body and align the striker relative to a latch. An integral striker bar having a unitary body extends out from the mounting plate via a neck portion of the mounting plate, the striker bar providing a rounded engagement area operable to receive a ratchet and pawl assembly on the latch. The engagement area of the striker bar has a diameter greater than the thickness of the mounting plate.

According to another aspect of the invention, there is provided a method for manufacturing a single-piece striker for a latch from a stock of a first thickness using a progressive die. The striker comprises a mounting plate, and a striker bar extending out from the mounting plate via a neck portion. The striker bar has a diameter greater than the first thickness. The method comprises stamping at least one mounting area in a portion of the stock, stamping at least one neck portion in another portion of the stock, and punching a void out of the neck portion, thereby defining a striker bar portion in the stock. The striker bar portion is compressed to a second thickness greater than the first thickness, thereby forming the striker bar. The stock is then cut, thereby forming the striker from the cut portion of stock.

### DETAILED DESCRIPTION OF THE DRAWINGS

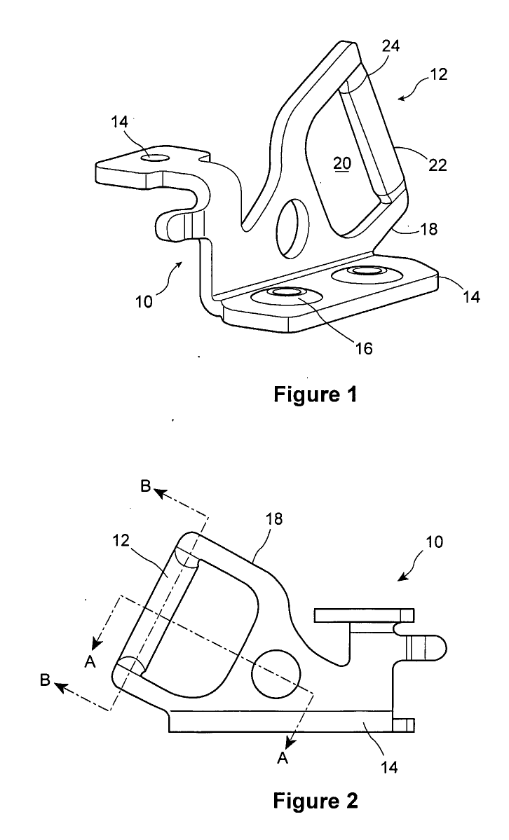

FIG. 1 is a perspective view of a striker formed in accordance with the invention;

FIG. 2 is a plan view of the striker shown in FIG. 1;

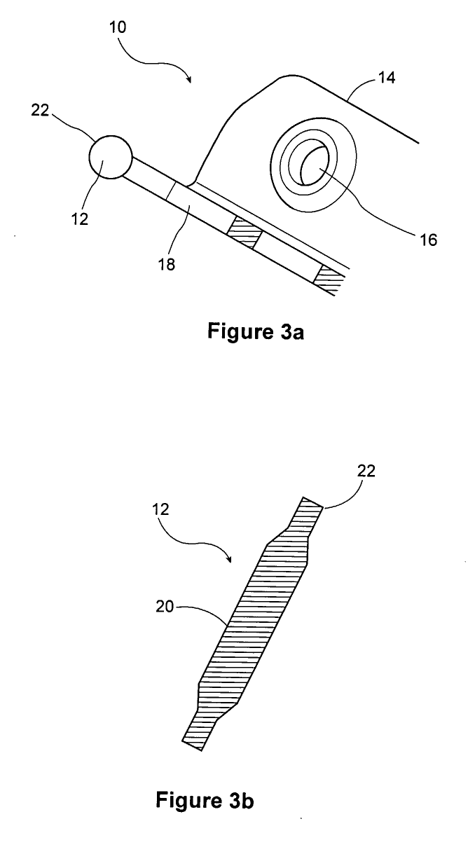

FIG. 3a is a cross section view of the striker shown in FIG. 2, taken along the lines A-A;

FIG. 3b is a cross section view of the striker shown in FIG. 2, taken along the lines B-B;

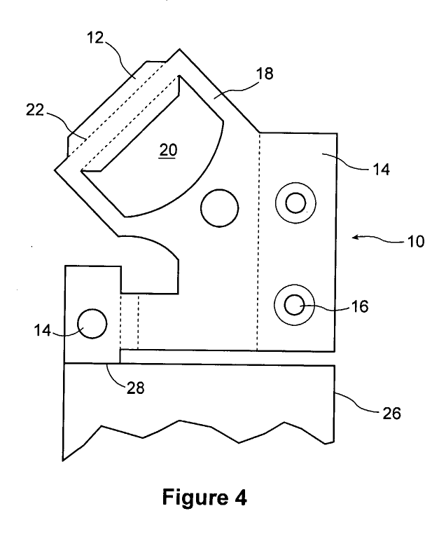

FIGS. 4a-d are perspective views of other strikers formed in accordance with the invention.

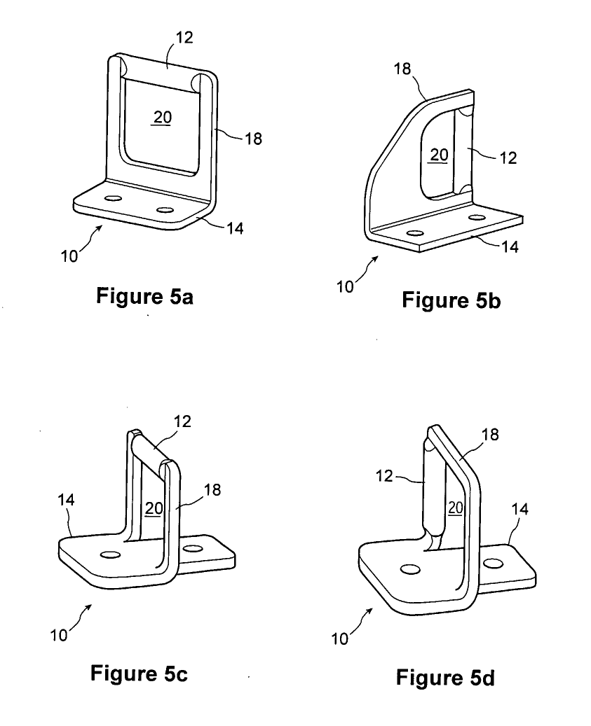

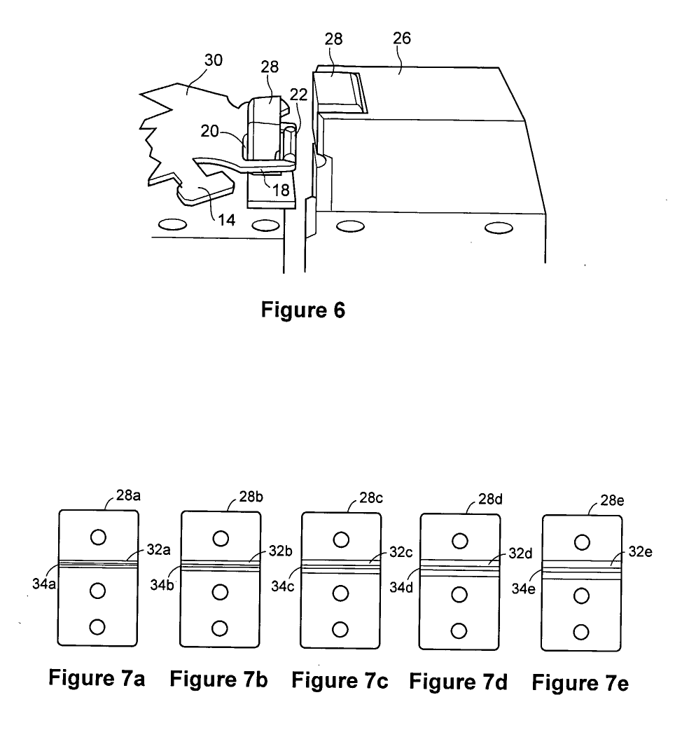

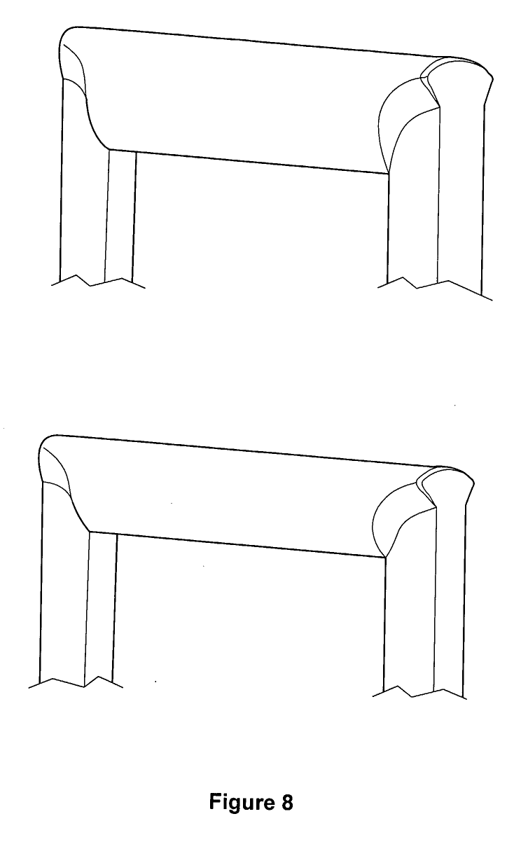

FIG. 5 is a partial plan view of a portion of stock used to form the striker shown in FIGS. 1 and 2; and

### DETAILED DESCRIPTION OF THE INVENTION

Referring now to FIGS. 1 and 2, a latch striker in accordance with a preferred aspect of the invention is shown generally at 10. Latch striker 10 is operable to be engaged by a conventional latch (not shown) mounted to a vehicle door or lift gate. Typically, the latch includes a ratchet and pawl assembly that is partially exposed through an opening (typically referred to as a “fishmouth”) in the latch body. As the automobile door, gate, hatch or trunk is closed, a striker bar 12 of the latch striker, as further described below, enters the fish mouth, actuating the pawl, and is thereby engaged by a ratchet on the latch.

Latch striker 10 is formed from a durable material such a cased-hardened, high strength steel like SAE 4130. Other steel alloys and materials will occur to those of skill in the art. The steel is provided as coil or bar stock and in the current embodiment, is 3 mm thick. Other thicknesses will occur to those of skill in the art.

Latch striker 10 includes a mounting plate 14 having a plurality of mounting holes 16. Mounting plate 14 can be flat, multi-tiered, or contoured to better fit the portion of the vehicle that they are mounted to. Mounting holes 16 are operable to receive fasteners such as screws, bolts or rivets to secure latch striker 10 to the vehicle body. Striker bar 12 is displaced away from mounting areas 12 by a neck portion 18. Neck portion 18 further aligns striker bar 12 with the latch's fishmouth (not shown) when the door, hatch or gate closes. Preferably, neck portion 18 is perpendicular to at least a portion of mounting plate 14. A void 20 in neck portion 18 allows the latch's ratchet and pawl (not shown) to fully envelope striker bar 16. Other void 20s may be provided in latch striker 10 in order to reduce the weight and amount of material used in the striker.

Preferably, striker bar 12 is straight along its longitudinal axis. Striker bar 12 provides a unitary body including a rounded engagement area 22 to properly receive the latch. As can be clearly seen in FIGS. 3a and 3b, striker bar 12 is rounded and is thicker in diameter than the connecting sheet metal in neck portion 18. Engagement area 22 of striker bar 12 has a diameter greater than the thickness of the connecting sheet metal in order to properly withstand the impact of the ratchet, and to resist deformation. In the current embodiment, engagement area 22 of striker bar 12 has a diameter of 6 mm. The cross-sectional shape of engagement area 22 is not particularly limited, and can be round, oval, or round or oval-flattened on one or two sides. Other cross-section shapes of engagement area 22 will occur to those of skill in the art.

A sloped area 24 is provided on each side of engagement area 22 to provide a smooth transition in thickness and shape from neck portion 18 to engagement area 22. The shape of sloped area 24 is not particularly limited and can be a regular tapered shape, a chamfered or rounded blended shape, shaped with a stepped level, or shaped with a shoulder. Other shapes of sloped area 24 will occur to those of skill in the art.

In the current embodiment, latch striker 10 is formed using a progressive die (not shown). Coil or bar stock 26 is run through a progressive die to form each latch striker 10. In the current embodiment, coil stock is used, and excess material is cut away from stock 26. During different stages of the die run, portions of the stock 26 are progressively bent (as indicated by the dashed bend lines) to form mounting plate 14 and neck portion 18. Also during the die run, mounting holes 16 and void 20 are punched out of the stock. After void 20 is punched out, a flat striker bar 12 runs between the two ends of neck portion 18. At this stage of forming, striker bar 12 runs the length of the stock, is 3 mm thick (the same as the starting stock), and is approx 9 mm wide. At a subsequent station in the progressive die, the flat striker bar 12 is compressed width-wise, thereby rounding the striker bar and forming engagement area 22 and sloped areas 24 (as indicated by the dotted lines). Now, striker bar 16 has a diameter of 6 mm. Finally, the stock is cut along line 28 and a fully-formed latch striker 10 falls into a parts bin. By using cold-forming techniques on a progressive die to produce the striker bar, a higher level of consistency is achieved over prior art methods. If desired, latch striker 10 can be electro-plated after forming.

It will be apparent to those of skill in the art that the order of steps taken using the progressive die can vary, in order to optimize the manufacture of latch striker 10. It will also be apparent to those of skill in the art that the thickness of the stock, and the final diameter of engagement area 22 can vary, depending on the materials used and the requirements of the vehicle. Referring now to FIGS. 5a-d, other embodiments of the invention are shown. As can be seen from the figures, rounded engagement area 22 can be located in different positions, alignments, and have different axes of engagement relative to mounting plate 14, depending on the requirements of the vehicle.

What is claimed is:

1. A single piece striker for a latch formed from stock to include:
at least one mounting plate, operable to mount the striker to an automotive vehicle;
an integral striker bar, extending away from a neck portion of the mounting plate, the striker bar having an engagement area operable to receive a ratchet and pawl assembly on the latch;
a void in the neck portion adjacent the striker bar; and
wherein the engagement area of the striker bar has a diameter greater than the thickness of the stock.

2. The striker of claim 1, wherein the engagement area on the striker bar includes a rounded surface for engagement with the ratchet and pawl assembly on the latch.

3. The striker of claim 2, wherein the striker bar is cold-formed from a flat portion of the stock and compressed to produce the desired roundness and diameter for the engagement area of the striker bar.

4. The striker of claim 3, wherein the striker bar is straight along its longitudinal axis.

5. The striker of claim 4, wherein the stock has a thickness of one of equal to and less than 3 mm thick, and the engagement surface of the striker bar has a diameter of at least 6 mm.

6. A method for manufacturing a single-piece striker for a latch from a stock of a first thickness using a progressive die, the striker comprising a mounting plate, and a striker bar extending away from the mounting plate and having a diameter greater than the first thickness, the method comprising:
forming at least one mounting plate in a portion of the stock;
forming at least one neck portion in another portion of the stock;
creating a void out of the neck portion, thereby defining a striker bar portion in the stock using one of punching or cutting techniques;
compressing the striker bar portion to a second thickness greater than the first thickness to create the striker bar; and
cutting the stock, thereby creating the striker from the cut portion of stock.

7. The method of claim 6, wherein compressing the striker bar portion of the stock further provides a rounded engagement surface for the striker bar.

8. The method of claim 7, wherein compressing the striker bar portion of the stock is done using a series of dies having a progressively rounder shaper.

9. The method of claim 8, wherein at least some of the dies in the series of dies includes locator channels to retain the striker bar during compression.

10. The method of claim 9, wherein the depth of the locator channels decreases progressively over the series of dies that include locator channels.

11. The method of claim 10, further comprising creating at least one mounting hole out of the mounting area using at least one of punching or cutting techniques.

12. The method of claim 11, wherein the stock is a coil stock.

13. The method of claim 12, wherein the coil stock is SAE 410 steel.

14. The method of claim 13, wherein the first thickness is one of equal to and less than 3 mm, and the second thickness is at least 6 mm.
